(19) United States
(12) Patent Application Publication
(10) Pub. No.: US 2018/0273429 A1
(43) Pub. Date: Sep. 27, 2018

(54) GYPSUM-CEMENT DRY MIX AND PREFABRICATED CONSTRUCTION PARTS PRODUCED THEREFROM

(71) Applicants: Bernd Bruno Wilfried Eck, Thalang (TH); Hubert Lichtinger, Thalang (TH)

(72) Inventors: Bernd Bruno Wilfried Eck, Thalang (TH); Hubert Lichtinger, Thalang (TH)

(21) Appl. No.: 15/763,867

(22) PCT Filed: Sep. 29, 2016
(86) PCT No.: PCT/EP2016/073211

§ 371 Date: Jun. 12, 2018

(30) Foreign Application Priority Data
Sep. 29, 2015 (DE) 10 2015 218 759.4

(51) Int. Cl. C04B 28/14; C04B 16/08; C04B 24/16; C04B 22/10; C04B 22/16; C04B 24/24; B28B 1/14

(52) U.S. Cl. CPC C04B 28/14; C04B 16/085; C04B 24/16; C04B 2103/304; C04B 22/16; C04B 24/24; B28B 1/14; C04B 22/10

(57) ABSTRACT

The invention relates to a gypsum-cement dry mix, the use thereof and a method for producing prefabricated construction parts using the gypsum-cement dry mix. For this purpose, the gypsum-cement dry mix comprises: a binder containing calcium sulphate hemihydrate or a mixture having at least 50 wt. % thereof and hydraulic cement in a weight ratio of 5:1 to 3:1; an aggregate material selected from crushed wood, plastic, expanded clay, perlites or a foam material or a mixture thereof; additives containing at least one plasticiser, at least one air-entraining agent, at least one stabiliser, and at least one delayer/accelerator, wherein the additives are present in dry form, and the mass fraction of the sum of all the additives in the total mass of the dry mix is <1%, wherein the stabiliser is selected from fluorophosphates or condensed phosphates, wherein the delayer is a water-soluble anionic polymer, and wherein the stabiliser-delayer mass ratio is 3:1 to 1:3.

### TECHNICAL FIELD

The invention relates to a gypsum-cement dry mix and prefabricated building components made thereof.

### BACKGROUND

In the erection of steel structures a thick layer of inorganic material is normally applied to the metallic structural elements, in most cases a setting aqueous mixture sprayed onto the steel surface.

A sprayable fire-proofing composition is known from DE 37 80 674 T2 that contains a hydratable cement binder, an aggregate of crushed polystyrene, an air-entraining agent and a fiber component that can be sprayed onto a steel structural part and which adheres and sets there.

The disadvantage of the mixture referred to in DE 37 80 674 T2 is that it cannot be employed in conjunction with gypsum as the dissolved CaSO₄ in the cement can trigger the feared sulfate attack through the formation of new mineral compounds, e.g. thaumasite, syngenite, ettringite. For this reason the mixture is difficult to work with and the hardened material displays a high weight.

A mix of cement and gypsum would demonstrably lead to improved material properties. However, gypsum and cement in conventional conditions are difficult to work with as one material because, as already mentioned above, the calcium sulfate leads to undesired secondary reactions when the material hardens. The calcium aluminum hydrate in the cement reacts with sulfates in the so-called “sulfate attack” and the volume can increase by up to 300%. This leads to very large mechanical stresses, which, in turn, can lead to cracks and spalling.

DE 10 2010 048 339 B8 discloses an aqueous gypsum cement mixture that contains a binder of gypsum and cement, an aggregate of sand or foam, a flux mixed with an air-entraining agent, a retardant and water. This aqueous mixture can be sprayed onto steel girders, hardens in situ and can be employed in the manufacture of buildings. As the mixture is applied by spraying, it does however have the disadvantage of requiring a certain viscosity that enables the mixture to be pumped and sprayed. Another disadvantage of this aqueous mixture is that merely binder, aggregate and fibers can be premixed and packed in a dry state. Flux, retardant and air-entraining agent must be subsequently added in a precise dosage into an aqueous solution, for example, by means of a metering unit, to produce the sprayable mixture, whereby working with the mix involves considerably more effort. Particularly problematic is the precise metering of the retardant, preferred is citric acid, which is supplied in powder form and added directly to the mixing water on the building site. As the metering greatly depends on the climatic conditions, and as large quantities of citric acid are needed to achieve a prolonged working time, it is easy to add too much, which, due to the acidic pH value of the aqueous mixture, impacts negatively on the corrosion behavior of the galvanized surface of the steel structures. Also particularly disadvantageous is that many air pores in the aqueous mixture are destroyed by the high pressure during the spraying process. The high pressure at which the mixture is sprayed also reduces the percentage of the additive EPS (expanded polystyrene) per cubic metre of the mixture. This, in turn, leads to a higher requirement of the material, it being possible for the percentage weight of the binder to increase by up to 10% of the previously calculated requirement.

### SUMMARY

An object of the invention is to prepare a gypsum-cement dry mix that contains all the components, including the additives in a dry premixed state, so that merely water needs to be added in situ. The mixture should be easy to work with, harden quickly, and have low weight in its hardened state and enable the simple manufacture of prefabricated building components.

This object is solved by a novel gypsum-cement dry mix comprising
a binder, that contains calcium sulfate hemihydrate or a mix comprising at least 50 wt % of it and a hydraulic cement in a weight ratio of 5:1 to 3:1,
an aggregate selected from crushed wood, plastic, expanded clay, perlites or a foam or a mix thereof,
additives containing
   at least a flux,
   at least an air-entraining agent,
   at least a stabilizer,
   at least a retardant/accelerator,
      the additive being in a dry form and the mass fraction of the sum of all additives of the total mass of dry mix being <1%, the stabilizers being selected from fluorine phosphate or condensed phosphates, the retardant/accelerator being a water-soluble anionic polymer and the mass ratio stabilizer to retardant/accelerator being 3:1 to 1:3.

### BRIEF DESCRIPTION OF THE DRAWING

The sole FIGURE is a graph showing typical time profiles for the hardening of different gypsum-cement dry mixes

### DETAILED DESCRIPTION

In an advantageous embodiment the gypsum-cement dry mix comprises a binder, the calcium sulfate hemihydrate or a mix of this to at least 50 wt %/o and a hydraulic cement in a weight ratio of 5:1 to 3:1,
an aggregate selected from crushed wood, plastic, expanded clay, perlites or a foam or a mixture of these
additives, containing
   a flux,
   an air-entraining agent,
   a stabilizer,
   a retardant/accelerator,
      the additive being in a dry form and the mass fraction of the sum of all additive of the total mass of dry mix being <1%, the stabilizer being selected from fluorine phosphates or condensed phosphates, the retardant/accelerator being a water-soluble anionic polymer and the mass ratio stabilizer to retardant/accelerator being between 3:1 and 1:3.

Retardant/accelerator is defined in the sense of the invention as an additive which acts both as a retardant and as an accelerator.

According to the invention, all components of the gypsum-cement mix are in a dry state. The complete mixture is packed, storable and transportable in a dry state. High transport costs caused by additional weight of the liquid components are avoided by the gypsum-cement dry mix of the invention.

According to the invention the gypsum-cement dry mix comprises a binder containing gypsum (calcium sulfate hemihydrate) or at least a 55% mixture thereof and a hydraulic cement in a weight ratio of between 3:1 and 5:1, preferably 4:1 to 5:1.

As is generally known, calcium sulfate hemihydrate (CaSO₄.1/2H₂0) is manufactured by heating of calcium sulfate dihydrate. Depending on the purity of the original calcium sulfate dihydrate the calcium sulfate hemihydrate used in the invented process of the invention contains up to 45 wt % inert impurities.

Calcium sulfate hemihydrate can occur in two modifications, alpha hemihydrate and beta hemihydrate. Both react with water under the back formation of calcium sulfate dihydrate (the actual gypsum). In the invention both modifications can be used either singly or in a mixture.

According to the invention, hydraulic cement is used as the cement, preferably Portland or limestone cement. Hydraulic cement hardens through the chemical interaction with water. In this process the metal oxides in the cement first react with water to form hydroxides and these then crystallize and become matted. It is important that all the cement grains are surrounded by water in order to ensure uniform hardening.

According to the invention, the gypsum-cement dry mix contains an aggregate.

According to the invention, the aggregate is selected from crushed/recycled wood, plastic, expanded clay, perlites, or a foam, or a mixture thereof. The advantage is that a high variability of aggregate materials is possible that can be adapted to the corresponding demands on the hardened material.

If foam is used as an aggregate, every foam can in principle be used, i.e. thermoplastic foams, such as expanded polystyrene (EPS, best known make: Styropor polyurethane foam) expanded polypropylene, (EPP), expanded PVC (EPVC), elastomer foams, such as polyurethane (PUR) soft foam and nitrile butadiene (NBR) foam as well as thermosetting foams, such as PUR hard foam and phenol formaldehyde (PF) foam.

In one embodiment the aggregate is foam, the weight ratio binder to foam being between 15:1 and 45:1, preferably between 35:1 and 20:1, particularly preferred 30:1.

In one embodiment the foam is recycled expanded polystyrene (recycled EPS, expanded polystyrene) with a medium particle size of 1-8 mm.

According to the invention, the mixture can also contain reinforcement in the form of polymer fibers from all known synthetic and natural polymers. Preferred is the use of polypropylene fibers.

According to the invention the gypsum-cement dry mix contains additives.

These act in their combination as facilitators and ensure the compatibility between gypsum and cement. They prevent undesired secondary reactions, such as, for example, the above-mentioned “sulfate attack”.

According to the invention the additives are in a dry state and the mass fraction of the sum of all additives of the total mass of dry mix is <1%.

According to the invention the gypsum-cement dry mix contains as an additive at least a flux.

In one embodiment the flux (also referred to as a super plasticizer in the technical vernacular) is an organic flux.

In one embodiment the flux contains anionic surfactants, e.g. on the basis of lignosulfonates, melamine sulfonates, naphthalene sulfonates, polycarboxylate, sodium benzoate, particularly preferred sodium dodecyl sulfate.

In one embodiment the flux additionally contains antibacterial agents.

According to the invention, the gypsum-cement dry mix contains at least one air-entraining agent.

In one embodiment the air-entraining agent is selected so that during mixing the surface tension of the air pores formed withstand the setting process and the air-entraining agent is, however, at the same time compatible with the other additives of the gypsum cement mixture.

So far flux and air-entraining agents could only be used in aqueous solution. The advantage of the invention is that now an air-entraining agent is used in a dry state, which in turn significantly simplifies working with the gypsum cement mixture.

In one embodiment the air-entraining agent contains anionic surfactants.

In one form the anionic surfactants are selected from carboxylates, sulfonates and/or sulfates.

In one form the anionic surfactants comprise sodium dodecyl sulfate.

A constant moisture within the material is important for the uniform setting of the gypsum cement mixture because the crystallization of the cement components as well as the gypsum only takes place if sufficient water is present. So far the mixture was usually mixed with cellulose fibers for this.

According to the invention the gypsum-cement dry mix contains as an additive at least one stabilizer.

In one embodiment the gypsum-cement dry mix contains as an additive one stabilizer.

The stabilizer can store water and ensures a sufficient quantity of water for the cement hardening process and gypsum setting within the mixture. The advantage of this is that it is easier to process the mixture into a mix that can be pumped and cast.

Another fundamental advantage of the addition of stabilizers is that it prevents cracks in the material and irregular structures within the material that reduce the strength. At the same time due to the castability and sprayability of the stirred mixture the previously calculated weight of the material can be retained.

According to the invention the stabilizer is selected from the material class of fluorine phosphates or condensed phosphates.

In one embodiment the stabilizer is selected from condensed phosphates.

In order to ensure ease of working with the gypsum-cement dry mix it is important to enable a certain amount of open time. To do this, at least one organic retardant/accelerator is added to the mixture.

According to the invention the gypsum-cement dry mix contains as an additive at least one retardant/accelerator, i.e. an addition that acts both as retardant as well as an accelerator.

The retardant/accelerator acts advantageously as a retardant in the first phase of the hardening process and as an accelerator during the second phase of the hardening process. The retardant/accelerator leads to a considerably improved handling of the processed gypsum-cement dry mix as time required to work with the mixture is prolonged, but the hardening process is accelerated, thus also avoiding cracks and stresses in the material.

According to the invention the retardant/accelerator is a water-soluble, anionic polymer.

In one embodiment the anionic, water-soluble polymer is selected from polyacrylates, poly aspartic acid, polysuccinimide, and/or organic phosphates.

According to the invention the mass fraction of the retardant/accelerator is or, in the case of several retardants/accelerators, are the sum of all retardants/accelerators, 0.1 to 0.5 m % (mass percent), particularly preferred 0.2-0.4 m %, very particularly preferred 0.3 m % of the total mass of the dry mix.

The retardant/accelerator of the invention makes possible a quick hardening of the material after the necessary longer open time for working and this, in turn, can prevent the formation of cracks and stresses in the material.

According to the invention, the retardants/accelerators used advantageously do not move the pH value of the invented gypsum-cement dry mix mixed with the water of into the acidic range. In contrast to the current state of technology, this advantageously prevents corrosion of reinforced steel, in particular of construction steel or steel girders.

It has been surprisingly shown that the combination of the stabilizer in the invention and retardant/accelerator have a particularly advantageous effect on the working and hardening of the gypsum cement mixture.

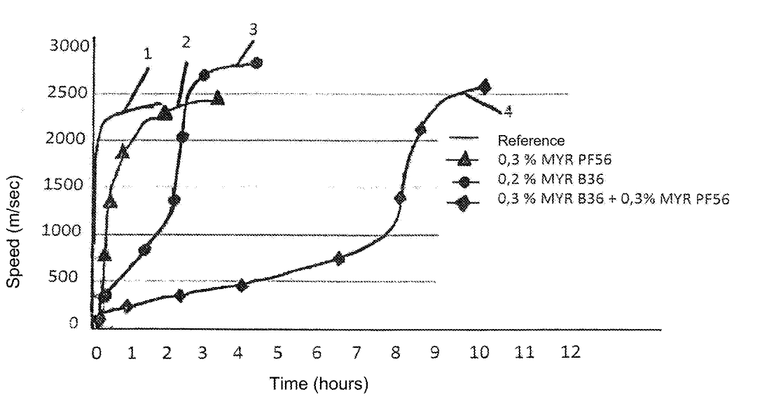

To illustrate this, the time profile for the hardening process of different compositions of dry mixes is depicted in the graph (FIG. 1).

The graphs show a typical time profile for the hardening of the respective gypsum-cement dry mixes:
Graph 1: Gypsum-cement dry mix without the addition of additives,
Graph 2: Gypsum-cement dry mix containing 0.3 m % stabilizer (MYR PF 56, Marcusyros S. L., Estepona, Spain, containing sodium metaphosphate), as a percentage of the total mass of the dry mix
Graph 3: Gypsum-cement dry mix containing 0.2 m % retardant/accelerator (MYR B 36, Marcusyros S. L, Estepona, Spain, containing anionic polymer, bulk density 550 kg/m), as a percentage of the total mass of the dry mix
Graph 4: Gypsum-cement dry mix containing a combination of 0.3 m % retardant/accelerator and 0.3 m % stabilizer (MYR B 36 and MYR PF 56, Marcusyros S. L., Estepona, Spain), as a percentage of the total mass of dry mix
   It can be seen that the setting process of a mixture without the addition of additives (Graph 1) starts immediately, which makes handling extremely difficult.

It is clear that the addition of the respective individual additives (Graph 2 and 3) already enable improved working with the processed mixture as the setting phase is slightly delayed. A combination of retardant/accelerator and stabilizer (Graph 4) leads, however, demonstrably to a significantly improved handling of the processed gypsum-cement dry mix as the time required for the open processing of the mixture is considerably prolonged, the hardening process is, however, accelerated and thus cracks and stresses in the material avoided.

According to the invention, the gypsum-cement dry mix therefore contains the retardant/accelerator in combination with the stabilizer in a mass ratio retardant/accelerator to stabilizer of between 3:1 and 1:3, preferred between 2:1 and 1:2, very particularly preferred 1:1.

The combination of stabilizer and retardant/accelerator in the invention thus acts as a retardant in the working phase, but as an accelerator for the hydration process in the setting phase.

According to the invention the gypsum-cement dry mix is mixed with 0.4 to 0.9 m %, preferred 0.5 to 0.8 m %, particularly preferred 0.67 m % water as a percentage of the total mass of the dry mix and can be used immediately. The use of clean tap water is preferred.

A substance is produced that is also described as a mixture that has the required viscosity for use in a casting and/or spraying process.

Prefabricated elements for the construction of buildings can be advantageously manufactured by the simple casting of the stirred substance in molds or by pumping into the molds. Furthermore, the substance produced from the gypsum-cement dry mix of the invention can be utilized in spraying processes. This serves, for example, for the manufacture of gypsum boards, lightweight components, as heat insulation material, as noise insulating and fire-resistant gypsum and for the manufacture of buildings of lightweight steel construction.

An object of the invention is likewise a castable and sprayable substance, containing the gypsum-cement dry mix of the invention and between 0.4 and 0.9 m %, preferred 0.5 to 0.8 m %, particularly preferred 0.67 m % water as a percentage of the total mass of the dry mix.

The substance advantageously hardens quickly after a longer open handling time and retains the temperature range for gypsum cement hardening in the process. Another fundamental advantage is that a special metering, e.g. via a metering device and the addition of liquid additives on site is not required. This enables a fundamentally easier handling of the mixture than is the case with aqueous mixtures in which liquid additives are also added. Stirring and mixing merely requires the addition of water.

The ease of handling advantageously simplifies the in-situ manufacture of the ready-to-use substance. This on site manufacture dispenses with high transport costs for a finished stirred mixture that has a much higher weight than the dry mix of the invention. The invention thus displays both considerable advantages in comparison with the state of technology both from economical as well as ecological viewpoints.

The invention also concerns prefabricated building components, manufactured from the invented gypsum-cement dry mix in its advantageous embodiments.

The prefabricated building components manufactured from the invented gypsum-cement dry mix are considerably lighter than conventional concrete elements; the weight saving is up to 75% of the weight of the standard materials. This means that light steel reinforcements can also be employed as molds. This, in turn, reduces the transport costs of the prefabricated building components considerably. An additional effect is the considerable cost savings caused by the fact that foundations and concrete slabs have to bear less weight and thus require fewer reinforcements.

Another decisive advantage is the enormously high fire resistance that the hardened material displays. The material can be categorized in the Class A1 (non-flammable). There is no smoke formation.

Another advantage is that the material can be especially employed for earthquake-affected regions too despite the high stability and resistance.

To manufacture the prefabricated building components, the invented gypsum-cement dry mix is stirred with the corresponding quantity of water and swiftly cast in prefabricated molds so that the cast wall does not display any gaps covered by the mass except at the opening points of the mold, e.g. for windows and doors wall-to-wall connections, wall to ceiling connections and wall to floor connections. This means that no joints and no thermal bridges are formed.

The molds are preferably made of metal, wood, plastic or, e.g. from bamboo. The molds are used laid out flat on production tables. However, it is also possible to use vertically standing molds for form elements.

In the case of flat manufacturing, different layers can be created in the elements and the stripping time reduced considerably. For example, a large prefabricated building component measuring 6×3×0.15 meters can be stripped in just 7 hours, whereas a comparable building component made of conventional building materials requires 24 hours before stripping is possible.

Function elements can be advantageously integrated in the prefabricated building component during the casting process. Function elements include, among other things, window and door frames, routing holes for media, such as, for example water pipes and electrical wiring or weight-bearing elements, e.g. for suspending WCs.

The invention will now be explained in more detail using the following design example:

An aqueous gypsum cement mixture is manufactured from the following components:

330 kg CaSO₄.1/2H₂0, 110 kg Portland cement CEM II—32.5/52.5/42.5 GREY/white, 100 kg sand (local crushed sand 0.25-2.00 mm), 1000 l extruded polystyrene (XPS) or expanded polystyrene (EPS; medium particle size 0.25-3 mm, recycled crushed granulate or newly manufactured EPS, 0.54 kg polypropylene fibers (length: 100 wt % 8 mm), flux (BIOFRA 05, H & B (Asia) Ltd., Hong Kong, Hong Kong, containing 10-25 m % sodium dodecyl sulfate and 60-70 m % limestone), air-entraining agent (BIOFRA L, H & B (Asia), Ltd., Hong Kong, Hong Kong, containing 10-30 m % sodium dodecyl sulfate and 70-90% limestone), retardant/accelerator (MYR B 36, Marcusyros S. L, Estepona, Spain, containing anionic polymer, water-soluble) and stabilizer (MYR PF 56, Marcusyros S. L., Estepona, Spain, containing sodium trimetaphosphate).

All components are mixed until homogeneity is achieved. This mixture is packed into sacks for storage.

The dry mix fed into the sacks is filled into the mixing/pumping/spraying device on site and mixed with approx. 250 kg clean tap water in order to attain the requisite viscosity of the material.

The aqueous gypsum cement mixture thus produced is then immediately introduced into the formwork by means of a pump or peristaltic pump.

The mixture in example 1 is employed for instance to create outside and inside walls and floors/ceilings/roof elements in monolithic house construction in steel, wood, bamboo or plastic frame construction. These prefabricated components are characterized by their low weight and high fire resistance.

Furthermore, the mixture can be employed, for example, for the manufacture of environmentally resistant garden furniture, furniture or voluminous bodies.

1.-8. (canceled)

9. A gypsum-cement dry mix, comprising:
a binder, containing calcium sulfate hemihydrate or a mixture of substances with at least 50 wt % calcium sulfate hemihydrate therein and hydraulic cement in a weight ratio between 5:1 and 3:1;
an aggregate selected from one or more of crushed wood, plastic, expanded clay, perlites, and foam; and
additives, including
at least one flux,
at least one air-entraining agent,
at least one stabilizer selected from fluorine phosphate or condensed phosphates, and
at least one retardant/accelerator, the retardant/accelerator being a water-soluble anionic polymer,
wherein the additives are present in a dry form and wherein a combined mass of all additives is less than 1% of the total mass of the dry mix, and
wherein a mass ratio of stabilizer to retardant/accelerator is between 3:1 and 1:3.

10. The gypsum-cement dry mix according to claim 9,
wherein the aggregate is a foam, and
wherein a weight ratio of binder to foam is between 15:1 and 45:1.

11. The gypsum-cement dry mix according to claim 10, wherein the foam is recycled expanded polystyrene having a medium particle size between 1 and 8 mm.

12. The gypsum-cement dry mix according to claim 9, wherein the flux is an organic flux.

13. The gypsum-cement dry mix according to claim 12, wherein the flux contains anionic surfactants.

14. The gypsum-cement dry mix according to claim 9, wherein the air-entraining agent contains anionic surfactants.

15. A prefabricated building component made from the gypsum-cement dry mix according to claim 9.

16. The prefabricated building component according to claim 15, comprising one or more function elements selected from the group consisting of a window, a door frame, a routing holes for media, and a weight-bearing element.

17. A method for manufacturing a prefabricated building component, comprising:
providing the gypsum-cement dry mix according to claim 9;
mixing the gypsum-cement dry mix with water, and
pouring the mixture of gypsum-cement dry mix and water into a mold.
